(19) United States
(12) Patent Application Publication
(10) Pub. No.: US 2022/0342180 A1
(43) Pub. Date: Oct. 27, 2022

(54) OPTICAL SYSTEM, CAMERA MODULE, AND AUTOMOBILE

(71) Applicant: JIANGXI JINGCHAO OPTICAL CO., LTD., Nanchang (CN)

(72) Inventors: Hairong ZOU, Nanchang (CN); Yuming LE, Nanchang (CN); Byoungtaek YOO, Nanchang (CN); Binli LAN, Nanchang (CN)

(73) Assignee: JIANGXI JINGCHAO OPTICAL CO., LTD., Nanchang (CN)

(21) Appl. No.: 17/760,754

(22) PCT Filed: Sep. 17, 2019
(86) PCT No.: PCT/CN2019/106226

§ 371 Date: Mar. 15, 2022

(51) Int. Cl. G02B 9/62; G02B 13/00; G02B 5/20

(52) U.S. Cl. CPC G02B 9/62; G02B 13/005; G02B 13/006; G02B 5/208

(57) ABSTRACT

Provided is an optical system, sequentially comprising, from an object side to an image side, a first lens having negative refractive power, an object side face of the first lens being convex, and an image side face being concave; a second lens having negative refractive power, an image side face of the second lens being concave; a third lens having positive refractive power, an object side face and an image side face of the third lens each being convex; a fourth lens having positive refractive power, an object side face and an image side face of the fourth lens each being convex; a lens unit having refractive power; and a stop arranged on an object side of the fourth lens. The optical system satisfies the condition of FOV/CRA>10.

### CROSS REFERENCE TO RELATED APPLICATIONS

This application is a national stage, filed under 35 U.S.C. § 371, of International Application No. PCT/CN2019/106226, filed on Sep. 17, 2019, and entitled “OPTICAL SYSTEM, CAMERA MODULE, AND AUTOMOBILE”, the content of which is incorporated herein in entirety by reference.

### TECHNICAL FIELD

The present disclosure relates to the field of optical imaging, and in particular, to an optical system, a camera module, and a vehicle.

### BACKGROUND

Currently, conventional cameras generally have a problem of small angel of field of view. Therefore, when the camera is used as an in-vehicle camera device, a vehicle still has a large blind spot of vision, and thus a driver cannot obtain enough peripheral scenes of a vehicle body, especially when the vehicle changes lanes at high speed, it is impossible to obtain information of vehicles at the side and the rear thereof in time, which is prone to potential safety hazards.

### SUMMARY

According to various embodiments of the present disclosure, an optical system, a camera module, and a vehicle are provided.

An optical system includes, successively in order from an object side to an image side:
a first lens having a negative refractive power, an object side surface of the first lens being convex, and an image side surface of the first lens being concave;
a second lens having a negative refractive power, an image side surface of the second lens being concave;
a third lens having a positive refractive power, an object side surface and an image side surface of the third lens being convex;
a fourth lens having a positive refractive power, an object side surface and an image side surface of the fourth lens being convex;
a lens unit having a refractive power; and
a stop arranged on an object side of the fourth lens;
wherein the optical system satisfies a following condition:

FOV/CRA>10;
wherein FOV is an angle of field of view of an imaging plane of the optical system in a diagonal direction, and CRA is an incident angle of a chief ray.

A camera module includes a photosensitive element; and the optical system as described above. The photosensitive element is arranged on the image side of the optical system.

A vehicle includes a vehicle body and the camera module as described above. The camera module is arranged on the vehicle body, and the camera module is configured to acquire environmental information around the vehicle.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate embodiments and/or examples of the contents disclosed herein, reference may be made to one or more of the accompanying drawings. Additional details or examples used to describe the drawings should not be construed as limiting the scope of any of the disclosed contents, the presently described embodiments and/or examples, and the presently understood best mode of these contents.

FIG. 1 is a schematic view of an optical system according to a first embodiment of the present disclosure.

FIG. 2 is a graph showing spherical aberration (mm), astigmatism (mm), and distortion (%) of the optical system according to the first embodiment.

FIG. 3 is a schematic view of an optical system according to a second embodiment of the present disclosure.

FIG. 4 is a graph showing spherical aberration (mm), astigmatism (mm), and distortion (%) of the optical system according to the second embodiment.

FIG. 5 is a schematic view of an optical system according to a third embodiment of the present disclosure.

FIG. 6 is a graph showing spherical aberration (mm), astigmatism (mm), and distortion (%) of the optical system according to the third embodiment.

FIG. 7 is a schematic view of an optical system according to a fourth embodiment of the present disclosure.

FIG. 8 is a graph showing spherical aberration (mm), astigmatism (mm), and distortion (%) of the optical system according to the fourth embodiment.

FIG. 9 a schematic view of a camera module to which an optical system is applied according to an embodiment of the present disclosure.

FIG. 10 is a schematic view of a vehicle to which a camera module is applied according to an embodiment of the present disclosure.

### DETAILED DESCRIPTION OF THE EMBODIMENTS

In order to facilitate understanding of the present disclosure, the present disclosure will be described more fully hereinafter with reference to the related drawings. Preferred embodiments of the present disclosure are shown in the accompanying drawings. However, the present disclosure may be embodied in many different forms and is not limited to the embodiments described herein. Rather, providing these embodiments is to provide a thorough and complete understanding of the present disclosure.

It should be noted that when an element is referred to as being “fixed to” another element, it can be directly on another element or an intermediate element may also be present. When an element is referred to as being “connected to” another element, it can be directly connected to another element or an intermediate element may be present at the same time. The terms “inner”, “outer”, “left”, “right” and similar expressions used herein are for the purpose of illustration only and do not imply that it is the only embodiment.

Currently, conventional cameras generally have a problem of small angel of field of view. Therefore, when the camera is used as an in-vehicle camera device, a vehicle still has a large blind spot of vision, and thus a driver cannot obtain enough peripheral scenes of a vehicle body, especially when the vehicle changes lanes at high speed, it is impossible to obtain information of vehicles at the side and the rear thereof in time, which is prone to potential safety hazards. In addition, the same kind of camera still has the problem that the overall definition of the captured image is not high. Therefore, the present disclosure provides an optical system, a camera module, and a vehicle to address the above problems.

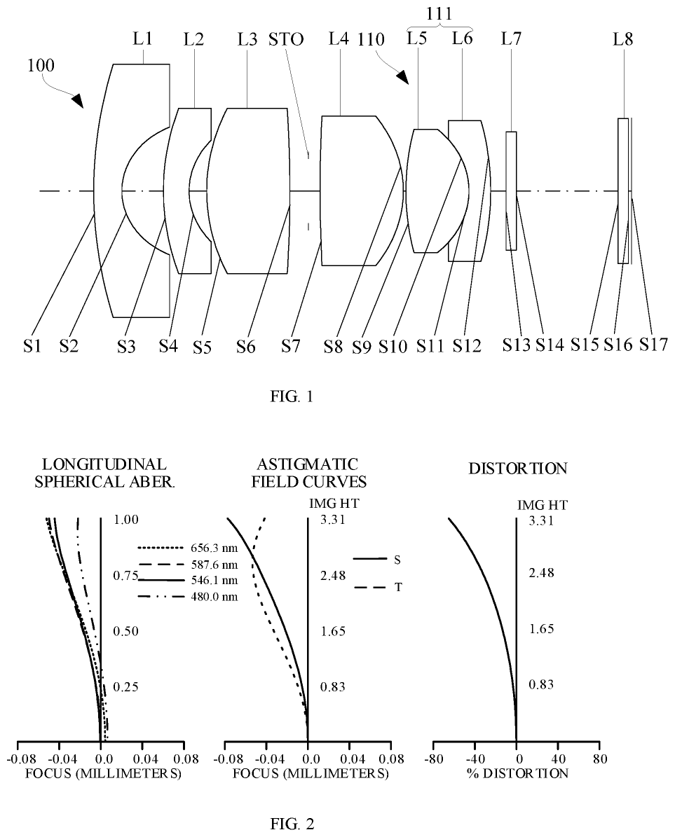

Referring to FIG. 1, an optical system 100 according to an embodiment of the present disclosure includes, successively in order from an object side to an image side: a first lens L1, a second lens L2, a third lens L3, a fourth lens L4, and a lens unit 110. In some embodiments, the lens unit 110 includes a fifth lens L5, and in this case, the optical system 100 has a five-lens structure. In other embodiments, the lens unit 110 includes a fifth lens L5 and a sixth lens L6, and in this case, the optical system 100 has a six-lens structure.

The first lens L1 includes an object side surface S1 and an image side surface S2. The second lens L2 includes an object side surface S3 and an image side surface S4. The third lens L3 includes an object side surface S5 and an image side surface S6. The fourth lens L4 includes an object side surface S7 and an image side surface S8. The fifth lens L5 includes an object side surface S9 and an image side surface S10. The sixth lens L6 includes an object side surface S11 and an image side surface S12. In addition, the optical system 100 further includes an imaging plane S17. The imaging plane S17 is located on an image side of the sixth lens L6. The imaging plane S17 can be understood as a photosensitive surface of a photosensitive element. However, it should be noted that the five-lens structure or the six-lens structure does not mean that the optical system 100 only includes five lenses or six lenses. In some embodiments, at least one of the first lens, the second lens, the third lens, the fourth lens, the fifth lens or the sixth lens may be a cemented lens composed of two or more lenses, that is, the optical system 100 having the above five-lens structure may actually include six, seven, or more lenses, while the optical system 100 having the six-lens structure may actually include seven, eight or more lenses.

In some embodiments, a stop STO is arranged in the optical system 100. The stop STO is arranged on an object side of the fourth lens L4. Specifically, the stop STO in some embodiments may be arranged between the second lens L2 and the third lens L3, or between the third lens L3 and the fourth lens L4.

The object side surfaces and the image side surfaces of the first lens L1, the second lens L2, the third lens L3, the fourth lens L4, the fifth lens L5, and the sixth lens L6 may be all spherical or all aspherical. In other embodiments, the object side surfaces and the image side surfaces of the first lens L1, the second lens L2, the third lens L3, the fifth lens L5, and the sixth lens L6 are all spherical, and the object side surface S7 and the image side surface S8 of the fourth lens L4 are aspherical.

When the object side surface or image side surface of the lens is aspherical, a formula of an aspherical surface may be referred to:

$$Z = \frac{c {r}^{2}}{1 + \sqrt{1 - ( k + 1 ) {c}^{2} {r}^{2}}} + {\sum }_{i} {Air}^{i}$$

where Z is a distance from a corresponding point on an aspherical surface to a plane tangent to a vertex of the surface, r is a distance from the corresponding point on the aspherical surface to an optical axis, c is a curvature of the vertex of the aspherical surface, k is a conic constant, and Ai is a coefficient corresponding to the i^{th} high-order term in the aspherical surface shape formula.

In some embodiments, the first lens L1 is made of glass, the second lens L2, the third lens L3, the fourth lens L4, the fifth lens L5, and the sixth lens L6 are made of plastic, so that the first lens L1 closest to the object side (outside) can better withstand the influence of an ambient temperature on the object side, and the optical system 100 can also have a lower production cost due to the other lenses being made of plastic.

In addition to the lenses made of glass or plastic as described above, in some embodiments, the first lens L1, the second lens L2, the third lens L3, the fourth lens L4, the fifth lens L5, and the sixth lens L6 are all made of plastic. In this case, the lenses made of plastic can reduce the weight of the optical system 100 and reduce the production cost. In some embodiments, the first lens L1, the second lens L2, the third lens L3, the fourth lens L4, the fifth lens L5, and the sixth lens L6 are all made of glass. In this case, the optical system 100 can withstand higher temperatures and have excellent optical properties.

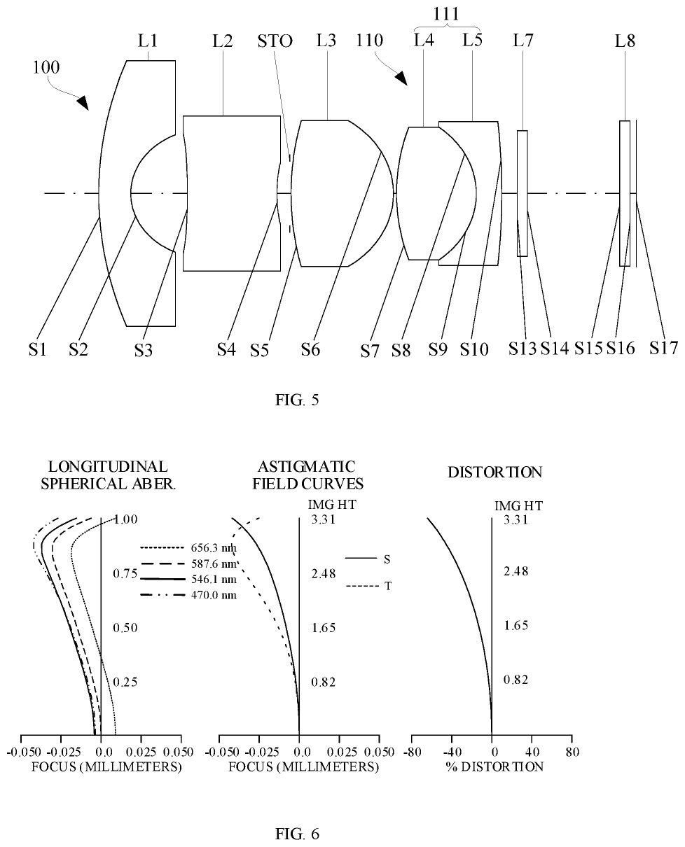

It should be noted that, referring to FIG. 5, the sixth lens L6 may not be arranged in the optical system 100 in some embodiments, and in this case, the optical system 100 will include the first lens L1, the second lens L2, the third lens L3, the fourth lens L4, and the fifth lens L5, that is, the optical system 100 have the five-lens structure.

For the optical system 100 having the five-lens structure, a stop STO may further be arranged, and the stop STO is arranged on the object side of the fourth lens L4. Specifically, the stop STO may be arranged between the second lens L2 and the third lens L3.

For the optical system 100 having the five-lens structure, in some embodiments, the object side surfaces and the image side surfaces of the first lens L1, the second lens L2, the third lens L3, the fourth lens L4, and the fifth lens L5 can be all spherical or all aspherical. In other embodiments, the object side surfaces and the image side surfaces of the first lens L1, the third lens L3, the fourth lens L4, and the fifth lens L5 are all spherical, while the object side surface S3 and the image side surface S4 of the second lens L2 are both aspherical.

In addition, for the optical system 100 having the five-lens structure, the first lens L1 may be made of glass, and the second lens L2, the third lens L3, the fourth lens L4, and the fifth lens L5 may be made of plastic. Therefore, the first lens L1 closest to the object side (outside) can better withstand the influence of the ambient temperature on the object side, and the optical system 100 can also have a lower production cost due to the other lenses being made of plastic.

Further, in some embodiments, the first lens L1, the second lens L2, the third lens L3, the fourth lens L4, and the fifth lens L5 are all made of plastic. In this case, the lenses made of plastic can reduce the weight of the optical system 100, and reduce the production cost. In some embodiments, the first lens L1, the second lens L2, the third lens L3, the fourth lens L4, and the fifth lens L5 are all made of glass. In this case, the optical system 100 can withstand higher temperatures and have excellent optical properties. In other embodiments, the first lens L1, the third lens L3, the fourth lens L4, and the fifth lens L5 are made of glass, and the second lens L2 is made of plastic.

In some embodiments, an infrared filter L7 made of glass is arranged on an image side of the lens unit 110. For the optical system 100 having the five-lens structure, the infrared filter L7 is arranged on an image side of the fifth lens L5. For the optical system 100 having the six-lens structure, the infrared filter L7 is arranged on an image side of the sixth lens L6. The infrared filter L7 includes an object side surface S13 and an image side surface S14. The infrared filter L7 is used to filter out infrared light to prevent the infrared light from reaching the imaging plane S17, thereby preventing the infrared light from affecting the imaging of normal images. The infrared filter L7 can be assembled with each lens as a part of the optical system 100, or can also be mounted between the optical system 100 and a photosensitive element when the optical system 100 and the photosensitive element are assembled into a module. In some embodiments, the infrared filter L7 may also be arranged on an object side of the first lens L1.

In some embodiments, a protective glass L8 is arranged on an image side of the last lens of the optical system 100, and the protective glass L8 is arranged on an image side of the infrared filter L7, to be close to the photosensitive element during assembly, thereby protecting the photosensitive element. The protective glass L8 includes an object side surface S15 and an image side surface S16.

In addition, in addition to the lenses with refractive powers, the optical system 100 may include a stop STO, a filter, a protective glass, a photosensitive element, a minor for changing the incident light path, and other elements.

It should be noted that the following embodiments involving conditions respectively include the cases where the optical system 100 has the five-lens structure and the six-lens structure.

In some embodiments, the optical system 100 satisfies a condition:

FOV/CRA>10; where FOV is an angle of field of view of the imaging plane of the optical system 100 in a diagonal direction, and CRA is an incident angle of a chief ray. The value of FOV/CRA can be 10.5, 10.6, 10.7, 10.8, or 10.9. When the above condition is satisfied, the optical system 100 has a larger angle of field of view to satisfy the requirements of electronic products such as mobile phones, in-vehicle devices, monitoring devices, and medical devices for a large viewing angle, and while an angle of light incident on the imaging plane S17 of the optical system 100 can also be reduced, thereby improving the imaging definition.

In some embodiments, the optical system 100 satisfies a condition: |((cuy s1)*(map s1)−(cuy s2)*(map s2))/2|>0.12. In an embodiment describing the five-lens structure, cuy s1 is a reciprocal of a radius of curvature (at the optical axis) of the object side surface S9 of the fifth lens L5, map s1 is a Y-direction semi-aperture of the object side surface S9 of the fifth lens L5, cuy s2 is a reciprocal of a radius of curvature (at the optical axis) of the image side surface S10 of the fifth lens L5, and map s2 is a Y-direction semi-aperture of the image side surface S10 of the fifth lens L5. In an embodiment describing the six-lens structure, cuy s1 is a reciprocal of a radius of curvature (at the optical axis) of the object side surface S11 of the sixth lens L6, map s1 is a Y-direction semi-aperture of the object side surface S11 of the sixth lens L6, cuy s2 is a reciprocal of a radius of curvature (at the optical axis) of the image side surface S12 of the sixth lens L6, and map s2 is a Y-direction semi-aperture of the image side surface S12 of the sixth lens L6. The value of |((cuy s1)*(map s1)−(cuy s2)*(map s2))/2| can be 0.22, 0.24, 0.25, 0.26, 0.27, or 0.28. When the above condition is satisfied, the processing difficulty of the fifth lens L5 can be reduced by controlling the radius of curvature and the Y-direction semi-aperture of the fifth lens L5 in the five-lens structure; or the processing difficulty of the sixth lens L6 can also be reduced by controlling the radius of curvature and the Y-direction semi-aperture of the sixth lens L6 in the six-lens structure.

It should be noted that, in an embodiment of the present disclosure involving a cemented lens 111, when the optical system 100 has the five-lens structure, the cemented lens 111 is composed of the fourth lens L4 and the fifth lens L5; when the optical system 100 has the six-lens structure, the cemented lens 111 is composed of the fifth lens L5 and the sixth lens L6.

In some embodiments, the optical system 100 satisfies a condition: 0<FH/R10. Where, FH is a focal length of the cemented lens 111, and f is an effective focal length of the optical system 100. The value of FH/f can be 4.70, 4.75, 4.80, 5.00, 5.30, 5.70, 5.90, 6.10, 6.15, or 6.20. When the above condition is satisfied, the cemented lens 111 can provide the optical system 100 with a positive refractive power, so that the optical system 100 has the characteristics of wide viewing angle, low sensitivity, and miniaturization.

In some embodiments, the optical system 100 satisfies a condition: ET S6>0.5, the unit of ET S6 is mm. Where, in an embodiment describing the five-lens structure, ET S6 is a thickness of the fourth lens L4 at the maximum effective radius; in an embodiment describing the six-lens structure, ET S6 is a thickness of the fifth lens L5 at the maximum effective radius. The value of ET S6 can be 1.5, 1.6, 1.7, or 1.8. When the above condition is satisfied, the processing difficulty of the cemented lens 111 can be reduced by controlling an edge thickness (a thickness of the lens at the maximum effective radius) of the fifth lens L5 in the five-lens structure or of the sixth lens L6 in the six-lens structure.

In some embodiments, the optical system 100 satisfies a condition: BFL/TTL>0.2. Where, BFL is an optical back focus of the optical system 100, and TTL is a distance on the optical axis from the object side surface S1 of the first lens L1 to the imaging plane S17 of the optical system 100. The value of BFL/TTL can be 0.24, 0.25, or 0.26. When the above condition is satisfied, the optical system 100 has a larger optical back focus, thereby having a telecentric effect, while the sensitivity and length of the optical system 100 can be reduced, so that the optical system 100 has a smaller volume. The optical back focus is a distance on the optical axis from the image side surface of the last lens to the imaging plane S17 in the optical system 100, in which the last lens is the lens closest to the imaging plane S17 in the optical system 100. In the five-lens structure, the optical back focus of the optical system 100 is a distance on the optical axis from the image side surface S10 of the fifth lens L5 to the imaging plane S17. In the six-lens structure, the optical back focus of the optical system 100 is a distance on the optical axis from the image side surface S12 of the six lens L6 to the imaging plane S17.

In some embodiments, the optical system 100 satisfies a condition: (SD S2)/(RDY S2)<0.95. Where, SD S2 is a Y-direction semi-aperture of the image side surface S2 of the first lens L1, and RDY S2 is a radius of curvature of the image side surface S2 of the first lens L1 at the optical axis. The value of (SD S2)/(RDY S2) can be 0.908, 0.912, 0.915, 0.917, or 0.918. When the above condition is satisfied, the radius of curvature and the Y-direction semi-aperture of the image side surface S2 of the first lens L1 can be controlled, so as to effectively control a degree of curvature of the first lens L1, reduce the processing difficulty of the first lens L1, and avoid the problem of uneven coating caused by an excessive degree of curvature of the first lens L1, thereby reducing the risk of ghosting.

In some embodiments, the optical system 100 satisfies a condition: −65≤Dist≤65. Where, Dist is an optical distortion of the optical system 100, in unit of %. The value of Dist can be −64, −63, −62, −61, 61, 62, 63, or 64. When the above condition is satisfied, the amount of distortion of the optical system 100 can be controlled to reduce the phenomenon of excessive distortion commonly existing in wide-angle lenses.

In some embodiments, the optical system 100 satisfies conditions: Nd1<1.8; Vd1>25. Where, Nd1 is a refractive index of the first lens L1 under d light, and Vd1 is an Abbe number of the first lens L1 under d light. The value of Nd1 can be 1.600, 1.610, 1.630, 1.660, 1.700, 1.730, 1.740, 1.760, or 1.765. The value of Vd1 can be 50.00, 61.00, 53.00, 57.00, 60.00, 60.80, 61.00, or 62.00. When the above conditions are satisfied, it is beneficial to correct an off-axis chromatic aberration of the optical system 100, thereby improving the resolution of the optical system 100.

In some embodiments, the optical system 100 satisfies conditions: Nd2>1.9; Vd2<25. Where, Nd2 is a refractive index of a lens closest to the image side in the optical system 100 (in the five-lens structure, the lens closest to the image side is the fifth lens L5; in the six-lens structure, the lens closest to the image side is the sixth lens L6) under d light, Vd2 is an Abbe number of the lens closest to the image side in the optical system 100 under d light, and a wavelength of the d light is 587.56 nm. The value of Nd2 can be 1.928, 1.930, 1.935, 1.950, 1.970, 1.980, or 1.950. The value of Vd2 can be 19.40, 19.50, 19.70, 20.00, 20.30, 20.60, 20.70, 20.80, or 20.85. When the above conditions are satisfied, it is beneficial to correct the off-axis chromatic aberration of the optical system 100, thereby improving the resolution of the optical system 100.

In some embodiments, the object side surface S1 of the first lens L1 is coated with a protective film. In some embodiments, the optical system 100 satisfies conditions: H_{K}>500; F_{A}>50. Where, HK is a hardness of the first lens L1, the unit of H_{K} is 10⁷ Pa, F_{A} is an abrasion degree of the first lens L1, and the unit of F_{A} is %. The value of H_{K} can be 600, 610, 620, 650, 680, or 690. The value of F_{A} can be 70, 75, 80, 90, 100, 105, 110, or 113. When the above conditions are satisfied, the first lens L1 has higher hardness and abrasion degree. In addition, the protective film is provided to enable the first lens L1 to have functions of waterproof and scratch resistance, the first lens L1 can be effectively prevented from being scratched, the imaging quality can be prevented from being affected by problems such as scratches and adhesion of water droplets, and the service life of the optical system 100 can be increased.

### First Embodiment

In the first embodiment as shown in FIG. 1, an optical system 100 includes, successively in order from an object side to an image side: a first lens L1 having a negative refractive power, a second lens L2 having a negative refractive power, and a third lens L3 having a positive refractive power, a stop STO, a fourth lens L4 having a positive refractive power, a fifth lens L5 having a positive refractive power, and a sixth lens L6 having a negative refractive power, so that the optical system 100 has a six-lens structure. In addition, the fifth lens L5 and the sixth lens L6 are cemented to constitute a cemented lens 111. An infrared filter L7 and a protective glass L8 are further sequentially arranged on the image side of the sixth lens L6. The infrared filter L7 and the protective glass L8 may be or not be a part of the optical system 100. When the infrared filter L7 and the protective glass L8 are not provided, a distance from an image side surface S12 of the sixth lens L6 to an imaging plane S17 is still 5.499 mm. Similar to the following embodiments, the distance from the image side surface S12 of the sixth lens L6 to the imaging plane S17 is independent of whether the infrared filter L7 or the protective glass L8 is arranged. FIG. 2 is a graph showing spherical aberration (mm), astigmatism (mm), and distortion (%) of the optical system 100 according to the first embodiment, where the astigmatism and distortion graphs are data graphs at a reference wavelength. The reference wavelength in the following embodiments is 587.56 nm, and the unit of the ordinate of IMG HT in the astigmatism and distortion graphs in the following embodiments is mm.

An object side surface S1 of the first lens L1 is convex, and an image side surface S2 of the first lens L1 is concave.

An object side surface S3 of the second lens L2 is convex, and an image side surface S4 of the second lens L2 is concave.

An object side surface S5 of the third lens L3 is convex, and an image side surface S6 of the third lens L3 is convex.

An object side surface S7 of the fourth lens L4 is convex, and an image side surface S8 of the fourth lens L4 is convex.

An object side surface S9 of the fifth lens L5 is convex, and an image side surface S10 of the fifth lens L5 is convex.

An object side surface S11 of the sixth lens L6 is concave, and the image side surface S12 of the sixth lens L6 is convex.

The object side surfaces and the image side surfaces of the first lens L1, the second lens L2, the third lens L3, the fourth lens L4, the fifth lens L5, and the sixth lens L6 are spherical.

The first lens L1, the second lens L2, the third lens L3, the fourth lens L4, the fifth lens L5, and the sixth lens L6 are all made of glass.

The optical system 100 satisfies the following conditions:

FOV/CRA=10.4; where FOV is an angle of field of view of the imaging plane of the optical system 100 in a diagonal direction, and CRA is an incident angle of a chief ray. When the above condition is satisfied, the optical system 100 has a larger angle of field of view to satisfy the requirements of electronic products such as mobile phones, in-vehicle devices, monitoring devices, and medical devices for a large viewing angle, and while an angle of light incident on a photosensitive element at the image side of the optical system 100 can also be reduced, thereby improving the imaging definition.

The optical system 100 satisfies a condition: |((cuy s1)*(map s1)−(cuy s2)*(map s2))/2|=0.21. Where, cuy s1 is a reciprocal of a radius of curvature (at the optical axis) of the object side surface S11 of the sixth lens L6, map s1 is a Y-direction semi-aperture of the object side surface S11 of the sixth lens L6, cuy s2 is a reciprocal of a radius of curvature (at the optical axis) of the image side surface S12 of the sixth lens L6, and map s2 is a Y-direction semi-aperture of the image side surface S12 of the sixth lens L6. When the above condition is satisfied, the processing difficulty of the sixth lens L6 can be reduced by controlling the radius of curvature and the Y-direction semi-aperture of the sixth lens L6. It should be noted that, in an embodiment of the present disclosure involving a cemented lens 111, when the optical system 100 has a five-lens structure, the cemented lens 111 is composed of the fourth lens L4 and the fifth lens L5; when the optical system 100 has a six-lens structure, the cemented lens 111 is composed of the fifth lens L5 and the sixth lens L6.

The optical system 100 satisfies a condition: FH/f=4.63. Where, FH is a focal length of the cemented lens 111, and f is an effective focal length of the optical system 100. When the above condition is satisfied, the cemented lens 111 can provide the optical system 100 with a positive refractive power, so that the optical system 100 has the characteristics of wide viewing angle, low sensitivity, and miniaturization.

The optical system 100 satisfies a condition: ET S6=1.5, where ET S6 is a thickness of the fifth lens L5 at the maximum effective radius, and the unit of ET S6 is mm. When the above condition is satisfied, the processing difficulty of the cemented lens 111 can be reduced by controlling an edge thickness (a thickness of the lens at the maximum effective radius) of the sixth lens L6.

The optical system 100 satisfies a condition: BFL/TTL=0.26. Where, BFL is an optical back focus of the optical system 100, and TTL is a distance on the optical axis from the object side surface S1 of the first lens L1 to the imaging plane S17 of the optical system 100. When the above condition is satisfied, the optical system 100 has a larger optical back focus, thereby having a telecentric effect, while the sensitivity and length of the optical system 100 can be reduced, so that the optical system 100 has a smaller volume.

The optical system 100 satisfies a condition: (SD S2)/(RDY S2)=0.906. Where, SD S2 is a Y-direction semi-aperture of the image side surface S2 of the first lens L1, and RDY S2 is a radius of curvature of the image side surface S2 of the first lens L1 at the optical axis. When the above condition is satisfied, the radius of curvature and the Y-direction semi-aperture of the image side surface S2 of the first lens L1 can be controlled, so as to effectively control a degree of curvature of the first lens L1, reduce the processing difficulty of the first lens L1, and avoid the problem of uneven coating caused by an excessive degree of curvature of the first lens L1, thereby reducing the risk of ghosting.

The optical system 100 satisfies a condition: Dist=−65. Where, Dist is an optical distortion of the optical system 100, in unit of %. When the above condition is satisfied, the amount of distortion of the optical system 100 can be controlled to reduce the phenomenon of excessive distortion commonly existing in wide-angle lenses.

The optical system 100 satisfies conditions: Nd1=1.773; Vd1=49.62. Where, Nd1 is a refractive index of the first lens L1 under d light, and Vd1 is an Abbe number of the first lens L1 under d light. When the above conditions are satisfied, it is beneficial to correct an off-axis chromatic aberration of the optical system 100, thereby improving the resolution of the optical system 100.

The optical system 100 satisfies conditions: Nd2=2.003; Vd2=19.32. Where, Nd2 is a refractive index of a lens closest to the image side in the optical system 100 (which is the fifth lens L5 in the five-lens structure; which is the sixth lens L6 in the six-lens structure) under d light, Vd2 is an Abbe number of the lens closest to the image side in the optical system 100 under d light. When the above conditions are satisfied, it is beneficial to correct the off-axis chromatic aberration of the optical system 100, thereby improving the resolution of the optical system 100.

The object side surface S1 of the first lens L1 is coated with a protective film, and the optical system 100 satisfies conditions: H_{K}=700; F_{A}=65. Where, H_{K} is a hardness of the first lens L1, the unit of H_{K} is 10⁷ Pa, F_{A} is an abrasion degree of the first lens L1, and the unit of F_{A} is %. When the above conditions are satisfied, the first lens L1 has higher hardness and abrasion degree. In addition, the protective film is provided to enable the first lens L1 to have functions of waterproof and scratch resistance, the first lens L1 can be effectively prevented from being scratched, the imaging quality can be prevented from being affected by problems such as scratches and adhesion of water droplets, and the service life of the optical system 100 can be increased.

In the first embodiment, a focal length of the optical system 100 is indicated by f, and f=2.8923 mm, an f-number is indicated by FNO, and FNO=2.1, and the half (½) of an angle of field of view in a diagonal direction is indicated by FOV, and FOV=73 degrees (deg.).

In addition, various parameters of the optical system 100 are shown in Table 1. The elements from an object plane to the imaging plane S17 are arranged in the order of the elements in Table 1 from top to bottom. Surface numbers 1 and 2 indicate the object side surface S1 and the image side surface S2 of the first lens L1, respectively. That is, in the same lens, a surface with a smaller surface number is the object side surface, and a surface with a larger surface number is the image side surface. The Y radius in Table 1 is a radius of curvature of the object side surface or the image side surface indicated by corresponding surface number in a paraxial region. In the “thickness” parameter column of the first lens L1, the first value is a thickness of this lens on the optical axis, and the second value is a distance from the image side surface of this lens to the object side surface of the next lens on the optical axis. The “thickness” parameter indicated by the surface number 6 is a distance from the image side surface S6 of the third lens L3 to the stop STO. The value of the stop STO in the “thickness” parameter column is a distance from the stop STO to a vertex (the vertex refers to an intersection of the lens and the optical axis) of the object side surface of the next lens on the optical axis. By default, a direction from the object side surface of the first lens L1 to the image side surface of the last lens is a positive direction of the optical axis. When the value is negative, it means that the stop STO is arranged on the right side of the vertex of the object side surface of the lens. When the “thickness” parameter of the stop STO is a positive value, the stop STO is arranged on the left side of the vertex of the object side surface of the lens. The “thickness” parameter value indicated by the surface number 12 is a distance on the optical axis from the image side surface S12 of the sixth lens L6 to the object side surface S13 of the infrared filter L7. The value corresponding to the surface number 13 of the infrared filter L7 in the “thickness” parameter is a distance on the optical axis from the image side surface S14 of the infrared filter L7 to the object side surface S15 of the protective glass L8.

In addition, in the following embodiments, the refractive index, Abbe number, and focal length of each lens are values at a reference wavelength, and the reference wavelength is 587.56 nm.

TABLE 1
First Embodiment
f = 2.8923 mm, FNO = 2.1, 1/2 (FOV) = 73°

| | | | Y | | | | | Focal |
|---|---|---|---|---|---|---|---|---|
| Surface | Surface | Surface | radius | Thickness | | Refractive | Abbe | Length |
| Number | Name | Shape | (mm) | (mm) | Material | index | number | (mm) |
| 0 | Object | Spherical | Infinite | 3000 | | | | |
| | Plane | | | | | | | |
| 1 | First Lens | Spherical | 21.98 | 1.100 | Glass | 1.773 | 49.62 | −4.953 |
| 2 | | Spherical | 3.188 | 1.623 | | | | |
| 3 | Second | Spherical | 12.10 | 1.000 | Glass | 1.487 | 70.45 | −10.512 |
| 4 | Lens | Spherical | 3.502 | 0.689 | | | | |
| 5 | Third | Spherical | 9.157 | 3.250 | Glass | 1.911 | 35.25 | 9.019 |
| 6 | Lens | Spherical | −66.32 | 0.725 | | | | |
| | Stop | Spherical | Infinite | 0.450 | | | | |
| 7 | Fourth | Spherical | 75.00 | 3.250 | Glass | 1.773 | 49.62 | 7.193 |
| 8 | Lens | Spherical | −5.888 | 0.100 | | | | |
| 9 | Fifth Lens | Spherical | 12.41 | 2.463 | Glass | 1.773 | 49.62 | 4.033 |
| 10 | | Spherical | −3.800 | 0 | | | | |
| 11 | Sixth | Spherical | −3.800 | 0.850 | Glass | 2.003 | 19.32 | −5.519 |
| 12 | Lens | Spherical | −13.49 | 0.600 | | | | |
| 13 | Infrared | Spherical | Infinite | 0.400 | Glass | 1.517 | 64.20 | |
| 14 | Filter | Spherical | Infinite | 3.974 | | | | |
| 15 | Protective | Spherical | Infinite | 0.400 | Glass | 1.517 | 64.20 | |
| 16 | Glass | Spherical | Infinite | 0.125 | | | | |
| 17 | Imaging | Spherical | Infinite | 0.000 | | | | |
| | Plane | | | | | | | |

### Second Embodiment

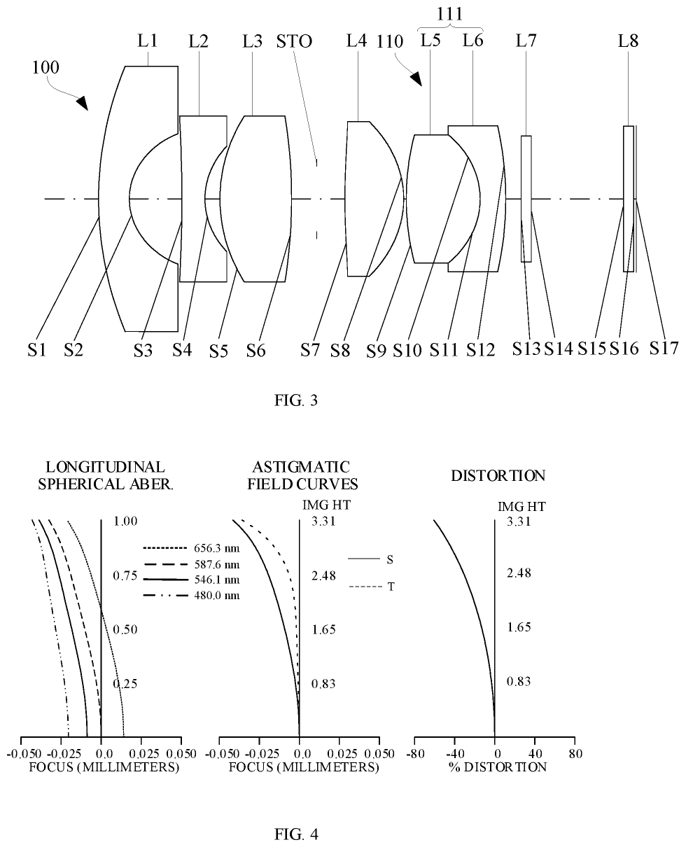

In the second embodiment as shown in FIG. 3, an optical system 100 includes, successively in order from an object side to an image side: a first lens L1 having a negative refractive power, a second lens L2 having a negative refractive power, a third lens L3 having a positive refractive power, a stop STO, a fourth lens L4 having a positive refractive power, a fifth lens L5 having a positive refractive power, and a sixth lens L6 having a negative refractive power, so that the optical system 100 has a six-lens structure. In addition, the fifth lens L5 and the sixth lens L6 are cemented to constitute a cemented lens 111. An infrared filter L7 and a protective glass L8 are further sequentially arranged on the image side of the sixth lens L6. The infrared filter L7 and the protective glass L8 may be or not be a part of the optical system 100. FIG. 4 is a graph showing spherical aberration (mm), astigmatism (mm), and distortion (%) of the optical system 100 according to the second embodiment, where the astigmatism and distortion graphs are data graphs at a reference wavelength.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is convex, and an image side surface S6 of the third lens L3 is convex.

An object side surface S7 of the fourth lens L4 is convex, and an image side surface S8 of the fourth lens L4 is convex.

An object side surface S9 of the fifth lens L5 is convex, and an image side surface S10 of the fifth lens L5 is convex.

An object side surface S11 of the sixth lens L6 is concave, and an image side surface S12 of the sixth lens L6 is convex.

The object side surfaces and the image side surfaces of the first lens L1, the second lens L2, the third lens L3, the fifth lens L5, and the sixth lens L6 are spherical. The object side surface S7 and the image side surface S8 of the fourth lens L4 are aspherical.

The first lens L1, the second lens L2, the third lens L3, the fourth lens L4, the fifth lens L5, and the sixth lens L6 are all made of glass.

In the second embodiment, an effective focal length of the optical system 100 is indicated by f, and f=2.8761 mm, an f-number is indicated by FNO, and FNO=2.1, and the half (½) of an angle of field of view in a diagonal direction is indicated by FOV, and FOV=71 degrees (deg.).

In addition, various parameters of the optical system 100 are shown in Table 3 and Table 4, and the definition of each of the parameters can be obtained from the first embodiment, which will not be repeated herein. Table 4 is a table of relevant parameters of the aspherical surface of each lens in Table 3, k represents a conic constant, and Ai represents a coefficient corresponding to the i^{th} high-order term in the aspherical surface shape formula.

TABLE 3
Second Embodiment
f = 2.8761 mm, FNO = 2.1, 1/2 (FOV) = 71°

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| 0 | Object | Spherical | Infinite | 3000 | | | | |
| | Plane | | | | | | | |
| 1 | First Lens | Spherical | 17.93 | 1.200 | Glass | 1.773 | 49.62 | −5.310 |
| 2 | | Spherical | 3.241 | 2.053 | | | | |
| 3 | Second | Spherical | −75.00 | 0.900 | Glass | 1.487 | 70.45 | −7.328 |
| 4 | Lens | Spherical | 3.766 | 0.584 | | | | |
| 5 | Third | Spherical | 7.857 | 2.800 | Glass | 1.911 | 35.25 | 6.955 |
| 6 | Lens | Spherical | −27.14 | 0.980 | | | | |
| | Stop | Spherical | Infinite | 1.100 | | | | |
| 7 | Fourth | Aspherical | 35.90 | 2.297 | Glass | 1.589 | 61.15 | 7.619 |
| 8 | Lens | Aspherical | −5.008 | 0.100 | | | | |
| 9 | Fifth Lens | Spherical | 13.35 | 2.885 | Glass | 1.773 | 49.62 | 4.296 |
| 10 | | Spherical | −4.000 | 0 | | | | |
| 11 | Sixth Lens | Spherical | −4.000 | 1.000 | Glass | 1.923 | 20.88 | −5.831 |
| 12 | | Spherical | −17.45 | 0.600 | | | | |
| 13 | Infrared | Spherical | Infinite | 0.400 | Glass | 1.517 | 64.20 | |
| 14 | Filter | Spherical | Infinite | 3.600 | | | | |
| 15 | Protective | Spherical | Infinite | 0.400 | Glass | 1.517 | 64.20 | |
| 16 | Glass | Spherical | Infinite | 0.100 | | | | |
| 17 | Imaging | Spherical | Infinite | 0 | | | | |
| | Plane | | | | | | | |

TABLE 4
Second Embodiment

| Surface | | |
|---|---|---|
| Number | 8 | 9 |
| k | 0.00E+00 | 0.00E+00 |
| A4 | −4.12E−04 | 4.97E−04 |
| A6 | 0.00E+00 | 3.35E−05 |
| A8 | 0.00E+00 | −7.57E−06 |
| A10 | 0.00E+00 | 4.01E−07 |
| A12 | 0.00E+00 | 0.00E+00 |
| A14 | 0.00E+00 | 0.00E+00 |
| A16 | 0.00E+00 | 0.00E+00 |
| A18 | 0.00E+00 | 0.00E+00 |
| A20 | 0.00E+00 | 0.00E+00 |

According to the information of parameters described above, the following data can be derived.

Second Embodiment

| | | | |
|---|---|---|---|
| f (mm) | 2.8761 | Dist | −60 |
| FNO | 2.1 | Nd1 | 1.773 |
| (1/2) FOV | 71 | Vd1 | 49.62 |
| FOV/CRA | 11 | H_{K} | 700 |
| \|((cuy sl)*(map s1)- | 0.23 | F_{A} | 65 |
| (cuy s2)*(map s2))/2\| | | | |
| FH/f | 4.9 | Nd2 | 1.923 |
| BFL/TTL | 0.24 | Vd2 | 20.88 |
| (SD S2)/(RDY S2) | 0.91 | ET S6 | 1.8 |

### Third Embodiment

In the third embodiment as shown in FIG. 5, an optical system 100 includes, successively in order from an object side to an image side: a first lens L1 having a negative refractive power, a second lens L2 having a negative refractive power, a stop STO, a third lens L3 having a positive refractive power, a fourth lens L4 having a positive refractive power, and a fifth lens L5 having a negative refractive power, so that the optical system 100 has a five-lens structure. In addition, the fourth lens L4 and the fifth lens L5 are cemented to constitute a cemented lens 111. An infrared filter L7 and a protective glass L8 are further sequentially arranged on the image side of the fifth lens L5. The infrared filter L7 and the protective glass L8 may be or not be a part of the optical system 100. FIG. 6 is a graph showing spherical aberration (mm), astigmatism (mm), and distortion (%) of the optical system 100 according to the third embodiment, where the astigmatism and distortion graphs are data graphs at a reference wavelength.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is convex, and an image side surface S6 of the third lens L3 is convex.

An object side surface S7 of the fourth lens L4 is convex, and an image side surface S8 of the fourth lens L4 is convex.

An object side surface S9 of the fifth lens L5 is concave, and an image side surface S10 of the fifth lens L5 is convex.

The object side surfaces and the image side surfaces of the first lens L1, the third lens L3, the fourth lens L4, and the fifth lens L5 are spherical. The object side surface S3 and the image side surface S4 of the second lens L2 are aspherical.

The first lens L1, the second lens L2, the third lens L3, the fourth lens L4, and the fifth lens L5 are all made of glass.

In the third embodiment, an effective focal length of the optical system 100 is indicated by f, and f=3.0 mm, an f-number is indicated by FNO, and FNO=2.0, and the half (½) of an angle of field of view in a diagonal direction is indicated by FOV, and FOV=72 degrees (deg.).

In addition, various parameters of the optical system 100 are shown in Table 5 and Table 6, and the definition of each of the parameters can be obtained from the first embodiment, which will not be repeated herein. Table 6 is a table of relevant parameters of the aspherical surface of each lens in Table 5, k represents a conic constant, and Ai represents a coefficient corresponding to the i^{th} high-order term in the aspherical surface shape formula.

TABLE 5
Third Embodiment
f = 3.0 mm, FNO = 2.0, 1/2 (FOV) = 72°

| | | | | | | | | Focal |
|---|---|---|---|---|---|---|---|---|
| Surface | Surface | Surface | Y radius | Thickness | | Refractive | Abbe | Length |
| Number | Name | Shape | (mm) | (mm) | Material | index | number | (mm) |
| 0 | Object | Spherical | Infinite | 3000 | | | | |
| | Plane | | | | | | | |
| 1 | First Lens | Spherical | 17.09 | 1.250 | Glass | 1.589 | 61.25 | −6.079 |
| 2 | | Spherical | 2.881 | 2.213 | | | | |
| 3 | Second | Aspherical | −34.62 | 3.500 | Glass | 1.808 | 40.55 | −8.329 |
| 4 | Lens | Aspherical | 8.735 | 0.500 | | | | |
| | Stop | Spherical | Infinite | 0.050 | | | | |
| 5 | Third | Spherical | 13.89 | 4.000 | Glass | 1.702 | 41.15 | 4.831 |
| 6 | Lens | Spherical | −3.950 | 0.120 | | | | |
| 7 | Fourth | Spherical | 9.595 | 3.117 | Glass | 1.729 | 54.67 | 4.139 |
| 8 | Lens | Spherical | −3.800 | 0 | | | | |
| 9 | Fifth | Spherical | −3.800 | 1.000 | Glass | 1.923 | 20.88 | −4.740 |
| 10 | Lens | Spherical | −32.59 | 0.600 | | | | |
| 11 | Infrared | Spherical | Infinite | 0.400 | Glass | 1.523 | 54.52 | |
| 12 | Filter | Spherical | Infinite | 3.600 | | | | |
| 13 | Protective | Spherical | Infinite | 0.400 | Glass | 1.523 | 54.52 | |
| 14 | Glass | Spherical | Infinite | 0.250 | | | | |
| 15 | Imaging | Spherical | Infinite | 0 | | | | |
| | Plane | | | | | | | |

TABLE 6
Third Embodiment

| Surface | | |
|---|---|---|
| number | 3 | 4 |
| k | 0.00E+00 | −5.00E+00 |
| A4 | −4.54E−04 | 6.13E−03 |
| A6 | −6.55E−05 | 8.71E−04 |
| A8 | 6.38E−07 | −3.34E−04 |
| A10 | −6.39E−07 | 1.11E−04 |
| A12 | 0.00E+00 | 0.00E+00 |
| A14 | 0.00E+00 | 0.00E+00 |
| A16 | 0.00E+00 | 0.00E+00 |
| A18 | 0.00E+00 | 0.00E+00 |
| A20 | 0.00E+00 | 0.00E+00 |

According to the information of parameters described above, the following data can be derived.

Third Embodiment

| | | | |
|---|---|---|---|
| f (mm) | 3.0 | Dist | −64 |
| FNO | 2.0 | Nd1 | 1.589 |
| (1/2) FOV | 72 | Vd1 | 61.25 |
| FOV/CRA | 10.3 | H_{K} | 590 |
| \|((cuy sl)*(map s1)- | 0.29 | F_{A} | 115 |
| (cuy s2)*(map s2))/2\| | | | |
| FH/f | 5.96 | Nd2 | 1.923 |
| BFL/TTL | 0.25 | Vd2 | 20.88 |
| (SD S2)/(RDY S2) | 0.92 | ET S6 | 1.8 |

### Fourth Embodiment

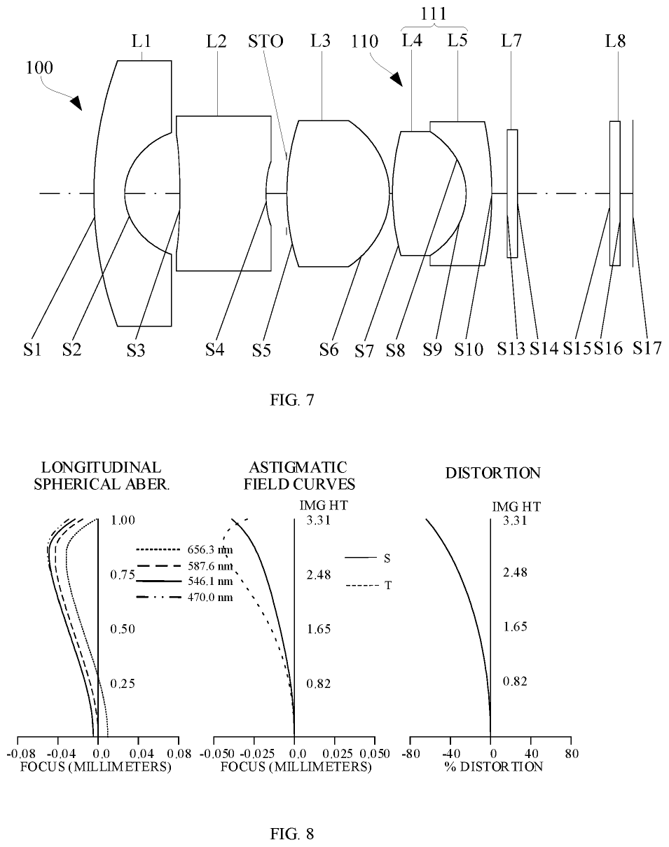

In the fourth embodiment as shown in FIG. 7, an optical system 100 includes, successively in order from an object side to an image side: a first lens L1 having a negative refractive power, a second lens L2 having a negative refractive power, a stop STO, a third lens L3 having a positive refractive power, a fourth lens L4 having a positive refractive power, and a fifth lens L5 having a negative refractive power, so that the optical system 100 has a five-lens structure. In addition, the fourth lens L4 and the fifth lens L5 are cemented to constitute a cemented lens 111. An infrared filter L7 and a protective glass L8 are further sequentially arranged on the image side of the fifth lens L5. The infrared filter L7 and the protective glass L8 may be or not be a part of the optical system 100. FIG. 8 is a graph showing spherical aberration (mm), astigmatism (mm), and distortion (%) of the optical system 100 according to the fourth embodiment, where the astigmatism and distortion graphs are data graphs at a reference wavelength.

An object side surface S1 of the first lens L1 is convex, and an image side surface S2 of the first lens L1 is concave.

An object side surface S3 of the second lens L2 is concave, and an image side surface S4 of the second lens L2 is concave.

An object side surface S5 of the third lens L3 is convex, and an image side surface S6 of the third lens L3 is convex.

An object side surface S7 of the fourth lens L4 is convex, and an image side surface S8 of the fourth lens L4 is convex.

An object side surface S9 of the fifth lens L5 is concave, and an image side surface S10 of the fifth lens L5 is convex.

The object side surfaces and the image side surfaces of the first lens L1, the third lens L3, the fourth lens L4, and the fifth lens L5 are spherical. The object side surface S3 and the image side surface S4 of the second lens L2 are aspherical.

The first lens L1, the third lens L3, the fourth lens L4, and the fifth lens L5 are all made of glass, and the second lens L2 is made of plastic.

In the fourth embodiment, an effective focal length of the optical system 100 is indicated by f, and f=2.99 mm, an f-number is indicated by FNO, and FNO=2.0, and the half (½) of an angle of field of view in a diagonal direction is indicated by FOV, and FOV=71.9 degrees (deg.).

In addition, various parameters of the optical system 100 are shown in Table 7 and Table 8, and the definition of each of the parameters can be obtained from the first embodiment, which will not be repeated herein. Table 8 is a table of relevant parameters of the aspherical surface of each lens in Table 7, k represents a conic constant, and Ai represents a coefficient corresponding to the i^{th} high-order term in the aspherical surface shape formula.

TABLE 7
Fourth Embodiment
f = 2.99 mm, FNO = 2.0, 1/2 (FOV) = 71.9°

| | | | Y | | | | | Focal |
|---|---|---|---|---|---|---|---|---|
| Surface | Surface | Surface | radius | Thickness | | Refractive | Abbe | Length |
| Number | Name | Shape | (mm) | (mm) | Material | index | number | (mm) |
| 0 | Object | Spherical | Infinite | 3000 | | | | |
| | Plane | | | | | | | |
| 1 | First Lens | Spherical | 20.00 | 1.200 | Glass | 1.589 | 61.25 | −6.126 |
| 2 | | Spherical | 2.989 | 2.148 | | | | |
| 3 | Second | Aspherical | −32.38 | 3.355 | Plastic | 1.544 | 56.00 | −9.848 |
| 4 | Lens | Aspherical | 6.658 | 0.798 | | | | |
| | Stop | Spherical | Infinite | 0.012 | | | | |
| 5 | Third | Spherical | 11.91 | 4.000 | Glass | 1.702 | 41.15 | 4.944 |
| 6 | Lens | Spherical | −4.216 | 0.120 | | | | |
| 7 | Fourth | Spherical | 12.19 | 2.868 | Glass | 1.729 | 54.67 | 4.944 |
| 8 | Lens | Spherical | −3.500 | 0 | | | | |
| 9 | Fifth Lens | Spherical | −3.500 | 1.000 | Glass | 1.923 | 20.88 | −4.807 |
| 10 | | Spherical | −18.86 | 0.600 | | | | |
| 11 | Infrared | Spherical | Infinite | 0.400 | Glass | 1.523 | 54.52 | |
| 12 | Filter | Spherical | Infinite | 3.600 | | | | |
| 13 | Protective | Spherical | Infinite | 0.400 | Glass | 1.523 | 54.52 | |
| 14 | Glass | Spherical | Infinite | 0.500 | | | | |
| 15 | Imaging | Spherical | Infinite | 0 | | | | |
| | Plane | | | | | | | |

TABLE 8
Fourth Embodiment

| Surface | | |
|---|---|---|
| number | 3 | 4 |
| k | 0.00E+00 | −4.13E+00 |
| A4 | −1.14E−05 | 7.88E−03 |
| A6 | −6.50E−05 | 1.20E−03 |
| A8 | 1.32E−06 | −4.39E−04 |
| A10 | −4.20E−07 | 1.24E−04 |
| A12 | 0.00E+00 | 0.00E+00 |
| A14 | 0.00E+00 | 0.00E+00 |
| A16 | 0.00E+00 | 0.00E+00 |
| A18 | 0.00E+00 | 0.00E+00 |
| A20 | 0.00E+00 | 0.00E+00 |

According to the information of parameters described above, the following data can be derived.

Fourth Embodiment

| | | | |
|---|---|---|---|
| f (mm) | 2.99 | Dist | −64 |
| FNO | 2.0 | Nd1 | 1.589 |
| (1/2) FOV | 71.9 | Vd1 | 61.25 |
| FOV/CRA | 10.3 | H_{K} | 590 |
| \|((cuy sl)*(map s1)- | 0.29 | F_{A} | 115 |
| (cuy s2)*(map s2))/2\| | | | |
| FH/f | 6.22 | Nd2 | 1.923 |
| BFL/TTL | 0.26 | Vd2 | 20.88 |
| (SD S2)/(RDY S2) | 0.92 | ET S6 | 1.5 |

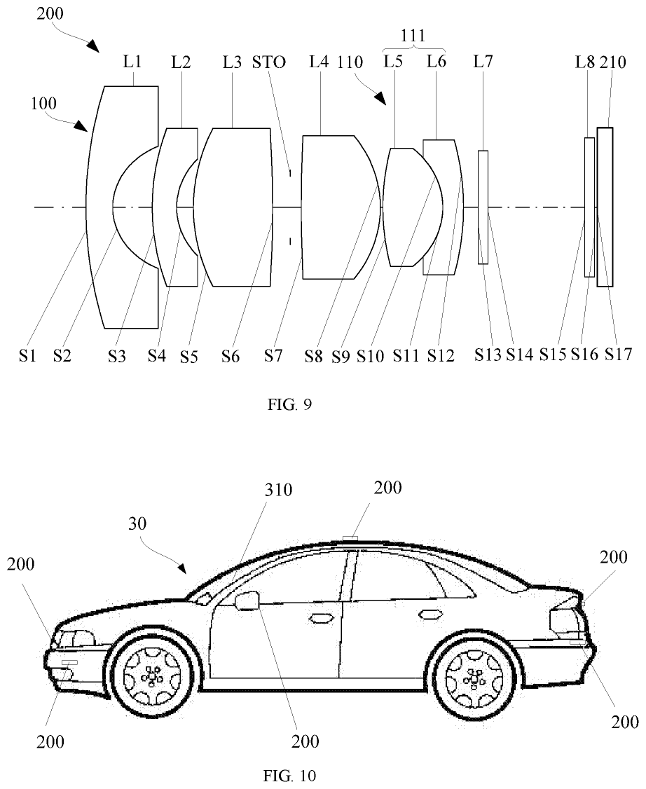

Referring to FIG. 9, in some embodiments, the optical system 100 and a photosensitive element 210 can be assembled to form a camera module 200 and the photosensitive element 210 is disposed at the image side of the optical system 100. The photosensitive element 210 may be a Charge Coupled Device (CCD) or a Complementary Metal Oxide Semiconductor (CMOS). By applying the above optical system 100, the camera module 200 can have a large viewing angle, and the imaging definition thereof can be improved.

In some embodiments, the lenses in the optical system 100 are relatively fixed to the photosensitive element 210, and in this case, the camera module 200 is a fixed-focus module. In other embodiments, a driving motor can further be configured to enable the photosensitive element 210 to move relative to the lenses in the optical system 100 to achieve a focusing function.

The camera module 200 can be applied to fields such as smart phones, smart watches, vehicles, surveillance, and medical, and specifically can be used as a mobile phone camera module, an in-vehicle camera module, or a surveillance camera module. When the camera module 200 is applied in a device, the device will have a large viewing angle, and the imaging definition thereof can be improved.

Referring to FIG. 10, in some embodiments, when the camera module 200 is applied to a vehicle 30 as an in-vehicle camera, the camera module 200 can be used as a front view camera, a rear view camera, or a side view camera of the vehicle 30. Specifically, the vehicle 30 includes a vehicle body 310. The camera module 200 can be mounted at any position of the vehicle body 310, such as the front side (e.g., at the air-inlet grille), the left front headlight, the right front headlight, the left rearview minor, the right rearview minor, the trunk cover, or the roof thereof. Secondly, a display device can further be arranged in the vehicle 30. The camera module 200 is connected to the display device in communication. Thus, images obtained by the camera module 200 on the vehicle body 310 can be displayed on the display device in real time, such that a driver can obtain environmental information around the vehicle body 310 in a wider range, as such, it is more convenient and safer for the driver to drive and park. When a plurality of camera modules 200 are provided to obtain scenes of different orientations, the image information obtained by the camera modules 200 can be synthesized and presented on the display device in a form of top views.

Specifically, the vehicle 30 includes at least four camera modules 200. The camera modules 200 are respectively mounted on the front side (e.g., at the air-inlet grill), the left side (e.g., at the left rearview minor), the right side (e.g., at the right rearview minor), and the rear side (such as the trunk cover) of the vehicle body 310, to build a vehicle surround view system. The vehicle surround view system includes four (or more) camera modules 200 mounted on the front, rear, left, and right sides of the vehicle body 310. The plurality of camera modules 200 can simultaneously capture scenes around the vehicle 30, and then, an image processing unit performs steps of distortion restoration, viewing angle conversion, image stitching, image enhancement, and the like on the information of the images captured by the camera modules 200, and finally, a seamless 360-degrees panoramic top view around the vehicle 30 is formed and displayed on the display device. Certainly, in addition to displaying a panorama view, a single-sided view in any orientation can also be displayed. In addition, a ruler line corresponding to the displayed image can also be configured on the display device to facilitate the driver to accurately determine an orientation and a distance of an obstacle.

By adopting the above-mentioned camera module 200, the blind spot of vision of the driver can be effectively reduced, so that the driver can obtain more information on the road conditions around the vehicle body, thereby reducing the potentially safety hazards when the vehicle is changing lanes, parking, turning and performing other operations.

In some embodiments, a driving recorder is mounted in the vehicle 30, and the image information obtained by the camera module 200 can be stored in the driving recorder.

In the description of the present disclosure, it should be understood that orientation or positional conditions indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” etc. are based on orientation or positional relationships shown in the drawings, which are merely to facilitate the description of the present disclosure and simplify the description, not to indicate or imply that the device or elements must have a particular orientation, be constructed and operated in a particular orientation, and therefore cannot be construed as a limitation on the present disclosure.

In addition, the terms “first” and “second” are used for description only, and cannot be understood as indicating or implying relative importance or implicitly indicating the number of technical features indicated. Thus, the features defined with “first” and “second” may include at least one of the features explicitly or implicitly. In the description of the present disclosure, the meaning of “plurality” is at least two, for example, two, three or the like, unless explicitly and specifically defined otherwise.

In the present disclosure, unless explicitly specified and defined otherwise, terms “mounting”, “connecting”, “connected”, and “fixing” should be understood in a broad sense. For example, it may be a fixed connection or a detachable connection, or an integration; may be a mechanical connection or electrical connection; may be a direct connection, or may be a connection through an intermediate medium, may be the communication between two elements or the interaction between two elements, unless explicitly defined otherwise. The specific meanings of the above terms in the present disclosure can be understood by one of those ordinary skills in the art according to specific circumstances.

In the description of this specification, description with reference to the terms “one embodiment,” “some embodiments,” “an example,” “specific example,” or “some examples”, etc., mean that specific features, structure, material or characteristics described in connection with the embodiment or example is included in at least one of embodiments or examples of the present disclosure. In this specification, schematic illustrations of the above terms are not necessarily directed to the same embodiment or example. Furthermore, the described particular features, structures, materials or characteristics may be combined in any suitable manner in any one or more of the embodiments or examples. Furthermore, those skilled in the art may incorporate and combine the different embodiments or examples described in this specification, as well as the features of the different embodiments or examples, without conflicting each other.

The technical features of the above-described embodiments can be combined arbitrarily. To simplify the description, not all possible combinations of the technical features in the above embodiments are described. However, all of the combinations of these technical features should be considered as being fallen within the scope of the present specification, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements falls in the protection scope of the present disclosure. Therefore, the protection scope of the present disclosure shall be subject to the appended claims.

What is claimed is:

1. An optical system, comprising, successively in order from an object side to an image side:
a first lens having a negative refractive power, an object side surface of the first lens being convex, and an image side surface of the first lens being concave;
a second lens having a negative refractive power, an image side surface of the second lens being concave;
a third lens having a positive refractive power, an object side surface and an image side surface of the third lens being convex;
a fourth lens having a positive refractive power, an object side surface and an image side surface of the fourth lens being convex;
a lens unit having a refractive power; and
a stop arranged on an object side of the fourth lens;
wherein the optical system satisfies a following condition:
FOV/CRA>10;
wherein FOV is an angle of field of view of an imaging plane of the optical system in a diagonal direction, and CRA is an incident angle of a chief ray.

2. The optical system according to claim 1, further satisfying a following condition:
BFL/TTL>0.2;
wherein BFL is an optical back focus of the optical system, and TTL is a distance on an optical axis from the object side surface of the first lens to the imaging plane of the optical system.

3. The optical system according to claim 1, further satisfying a following condition:
(SDS2)/(RDYS2)<0.95;
wherein SD S2 is a Y-direction semi-aperture of the image side surface of the first lens,
and RDY S2 is a radius of curvature of the image side surface of the first lens.

4. The optical system according to claim 1, further satisfying a following condition:
−65≤Dist≤65;
wherein Dist is an optical distortion of the optical system, in unit of %.

5. The optical system according to claim 1, further satisfying following conditions:
Nd1<1.8;Vd1>25;
wherein Nd1 is a refractive index of the first lens under d light, and Vd1 is an Abbe number of the first lens under d light.

6. The optical system according to claim 1, wherein the object side surface of the first lens is coated with a protective film.

7. The optical system according to claim 1, further satisfying following conditions:
H_{K}>500;F_{A}>50;
wherein H_{K} is a hardness of the first lens, a unit of H_{K} is 10⁷ Pa; F_{A} is an abrasion degree of the first lens, and a unit of F_{A} is %.

8. The optical system according to claim 1, further satisfying following conditions:
Nd2>1.9;Vd2<25;
wherein Nd2 is a refractive index of a lens closest to the image side in the optical system under d light, Vd2 is an Abbe number of the lens closest to the image side in the optical system under d light.

9. The optical system according to claim 1, wherein the optical system comprises the stop arranged between the second lens and the third lens, or arranged between the third lens and the fourth lens.

10. The optical system according to claim 1, wherein the lens unit comprises a fifth lens, and an image side surface of the fifth lens is convex, the fourth lens and the fifth lens are cemented into a cemented lens.

11. The optical system according to claim 10, further satisfying a following condition:

|((cuys1)*(maps1)−(cuys2)*(maps2))/2|>0.12;
wherein cuy s1 is a reciprocal of a radius of curvature of an object side surface of the fifth lens, map s1 is a Y-direction semi-aperture of the object side surface of the fifth lens, cuy s2 is a reciprocal of a radius of curvature of the image side surface of the fifth lens, and map s2 is a Y-direction semi-aperture of the image side surface of the fifth lens.

12. The optical system according to claim 10, further satisfying a following condition:
0<FH/f<10;
wherein FH is a focal length of the cemented lens, and f is an effective focal length of the optical system.

13. The optical system according to claim 10, further satisfying a following condition:
ETS6>0.5;
wherein ET S6 is a thickness of the fourth lens at a maximum effective radius, a unit of ET S6 is mm.

14. The optical system according to claim 1, wherein the lens unit comprises a fifth lens having a refractive power and a sixth lens having a negative refractive power; the sixth lens is arranged on an image side of the fifth lens; an image side surface of the fifth lens is convex; an object side surface of the sixth lens is concave, and an image side surface of the sixth lens is convex; the fifth lens and the sixth lens are cemented into a cemented lens.

15. The optical system according to claim 14, further satisfying a following condition:

|((cuys1)*(maps1)−(cuys2)*(maps2))/2|>0.12;
wherein cuy s1 is a reciprocal of a radius of curvature of the object side surface of the sixth lens, map s1 is a Y-direction semi-aperture of the object side surface of the sixth lens, cuy s2 is a reciprocal of a radius of curvature of the image side surface of the sixth lens, and map s2 is a Y-direction semi-aperture of the image side surface of the sixth lens.

16. The optical system according to claim 14, further satisfying a following condition:
0<FH/f<10;
wherein FH is a focal length of the cemented lens, and f is an effective focal length of the optical system.

17. The optical system according to claim 14, further satisfying a following condition:
ETS6>0.5;
wherein ET S6 is a thickness of the fifth lens at a maximum effective radius, a unit of ET S6 is mm.

18. The optical system according to claim 14, further comprising an infrared filter configured to filter out infrared light, wherein the infrared filter is arranged on an image side of the lens unit.

19. A camera module, comprising:
a photosensitive element; and
the optical system according to any one of claims 1 to 18,
wherein the photosensitive element is arranged on the image side of the optical system.

20. A vehicle, comprising:
a vehicle body; and
the camera module according to claim 19,
wherein the camera module is arranged on the vehicle body, and the camera module is configured to acquire environmental information around the vehicle.
